(19) United States
(12) Patent Application Publication
(10) Pub. No.: US 2022/0274023 A1
(43) Pub. Date: Sep. 1, 2022

(54) METHODS AND SYSTEM FOR ARTIFICIAL INTELLIGENCE POWERED USER INTERFACE

(71) Applicant: Fighter Base Publishing, Inc., Scottsdale, AZ (US)

(72) Inventors: Mark Vange, Scottsdale, AZ (US); Gabriele Morano, Rome (IT)

(21) Appl. No.: 17/618,589

(22) PCT Filed: Jun. 12, 2020
(86) PCT No.: PCT/US2020/037610

§ 371 Date: Dec. 13, 2021

Related U.S. Application Data
(60) Provisional application No. 62/861,433, filed on Jun. 14, 2019.

(51) Int. Cl. A63F 13/67; A63F 13/63; A63F 13/56; G06N 20/00

(52) U.S. Cl. CPC A63F 13/67; A63F 13/63; A63F 13/56; G06N 20/00

(57) ABSTRACT

Systems and methods for an artificial intelligence powered user interface according to various aspects of the present technology include a game engine that is powered by an artificial intelligence system that is able to receive minimal platform specific discrete user inputs and infer optimal in-game action. The game engine may be trained to generate a set of known, expected, or predicted behaviors for both non-player characters and actual players. The game engine may then present one or more events to players and then infer a player response based upon a received user input. The game engine may also be configured to measure success of each inference based on a comparison of a player's response to a set of predetermined goals.

### CROSS-REFERENCES TO RELATED APPLICATIONS

This application is a 371 of International PCT/US20/37610 filed Jun. 12, 2020, which claims the benefit of U.S. Provisional Patent Application No. 62/861,433, filed Jun. 14, 2019, and incorporates the disclosures of the applications by reference.

### BACKGROUND OF INVENTION

The term AI (Artificial Intelligence) has been used liberally in the video game industry in the past to describe what should more accurately be called non-player characters (NPC) and environments. Traditionally game AI was actually a classical state machine based on one or more software processes that would simulate action while being driven by code that was generated by a programmer. While behaviors manifested by such NPC characters can be quite sophisticated, they are ultimately governed by, and limited to, the imagination of the game designers and programmers. By contrast, true AI can generate unpredictable and novel behaviors that were not necessarily anticipated by the design. This creates both tremendous opportunities and challenges in creating good AI for video game context.

For example, game engines used in flight simulation and combat type of games commonly use a physics simulation tool combined with known physical properties of one or more vehicles such as: aircraft, tanks, cars, trucks, or ships to deterministically calculate the movement of a particular through its natural environment (e.g. how an aircraft flies through the air). With sufficiently complex simulation, the game engine can not only emulate simple flight of an aircraft but can also simulate more sophisticated phenomena such as: the impact of weather or moisture on flight conditions; the impact of drag or weight on performance of the aircraft; and the effect of varying levels of damage on the overall behavior of the aircraft.

During gameplay, current versions of flight simulation games take direct input from users through the use of a joystick or emulate a joystick with cursor keys, mouse movement, or other defined user inputs. The input is used to strictly emulate the behavior of the control system of a real aircraft; whether powered by a yoke or control stick, the left/right/up/down movement of the controller directly feeds into the movement of the control surfaces (ailerons, rudder, elevators) and this input acts as a basis for calculating results. Specifically, the control inputs received from the user are explicit and the resultant outcome deterministic. In these prior art games, a form of artificial intelligence has been used to power, or give life to, NPCs, which are commonly other aircraft in the air that the user interacts with, without any physics simulation or need for direct control inputs.

Flight games represent some of the most complex experiences available in video games and often require a large amount of training by a user to simply operate a high-performance aircraft, maintain orientation, manage power, temperature, and other flight envelope conditions. This up-front investment of time and energy has also been a barrier to the continued enjoyment of such games by new audiences that have grown accustomed to more approachable games that, while perhaps tough to master, are quicker to learn and enjoy.

An emerging trend in software products in general, and entertainment software in particular is that users want to have richer, more satisfying experiences with as little effort as possible. This has given rise to various genres of games like tappers (where a game involves pressing just one button repeatedly) and auto-battlers (where minimal instructions like “attack” are given and outcomes are determined algorithmically). The ultimate expression of this trend is the rapid growth in the consumption of both streaming and e-sports content where the player is completely passive, watching high-skill players create compelling content.

With the increased use of mobile phones and other portable computing devices to play games, the traditional joystick and other high-fidelity input devices have become less widespread leading to a need for an inference-based method of control. This is particularly true when using games that are, or can be played cross platform. To maintain fairness and to give players a similar competitive landscape, it is important that the actual capabilities of the game characters and objects remain the same even if the abilities of the control devices diverge wildly. As an example, in a flight game played on a personal computer, the most common control mechanism is a joystick. In contrast, a player that is playing the same flight game on a mobile phone will likely not have a joystick with them. Therefore, the phone screen interface becomes the primary control mechanism and the game should adapt accordingly.

Prior art systems solved this issue by drawing a virtual joystick on the screen and allowing the user to manipulate it in place of a physical joystick. Unfortunately, this creates a very unsatisfying experience and puts the player on the phone at a tremendous disadvantage compared to a player using an actual joystick. A solution is needed that bridges this gap to level the playing field and make it possible for players with limited controllers to have the same quality of controls as those with traditional controllers.

### SUMMARY OF THE INVENTION

Systems and methods for an artificial intelligence powered user interface according to various aspects of the present technology include a game engine that is powered by an artificial intelligence system that is able to receive minimal platform specific discrete user inputs and infer optimal in-game (or in-environmental) action. The game engine may be trained to generate a set of known, expected, or predicted behaviors for both non-player characters and actual players. The game engine may then present one or more events to players and then infer a player response based upon a received user input. The game engine may also be configured to measure success of each inference based on a comparison of a player's response to a set of predetermined goals.

### BRIEF DESCRIPTION OF THE DRAWINGS

A more complete understanding of the present invention may be derived by referring to the detailed description when considered in connection with the following illustrative figures. In the following figures, like reference numbers refer to similar elements and steps throughout the figures.

FIG. 1 is a flow chart of an inference process used to determine a user's intent in accordance with an exemplary embodiment of the present technology;

FIG. 2 representatively illustrates a block diagram of an AI powered system in accordance with an exemplary embodiment of the present technology; and

FIG. 3 representatively illustrates a flow chart of input processing in accordance with an exemplary embodiment of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of portable computing devices, display systems, communication protocols, networks, software/firmware, and the like. In addition, the present technology may be practiced in conjunction with any number of electronic devices and communication networks, and the system described is merely one exemplary application for the technology.

Systems and methods for an artificial intelligence powered user interface according to various aspects of the present technology may operate in conjunction with any suitable computing device, communication network, and application or game server. The disclosed system may be installed on a user device or it may be streamed to a user device from a remote cloud-based application server. Various representative implementations of the present technology may be applied to any system for communicating user actions to an application or game configured to generate context-based responses to the received user actions.

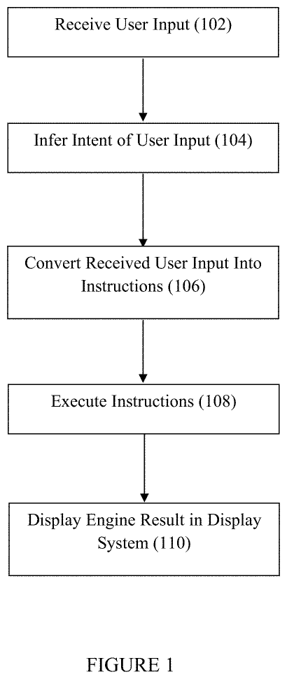

Referring to FIG. 1, in one embodiment, an artificial intelligence powered game engine may receive a user input from a user device (102). The artificial intelligence powered game engine may infer an intent, or desired in-game response, of the user input (104). The artificial intelligence powered game engine may be adapted to interpret the user's non-specific or over-broadly expressed intent from the user input and produce a high value outcome. For example, in the context of an autonomous vehicle embodiment, the user's non-specific intent might comprise stepping up to a curb around 6 pm and an artificial intelligence powered engine may infer that the user wishes to be taken to a restaurant. Based on the user's previous similar inputs at about that same time, the artificial intelligence powered engine may more specifically infer that the user's actual intent is to be taken to a particular Italian restaurant. In the context of a video game, the user may represent one actor in the game and the NPCs represent other actors in the game thus creating situations where the game must respond to platform specific discrete user inputs via a controller device such as: a joystick; mouse; keyboard; wireless controller, or touch screen.

To accomplish this, the artificial intelligence powered game engine is able to evolve the inferences made with respect to the user inputs. Over time, the artificial intelligence powered game engine may incorporate contextual awareness into the process used to generate the inferences made. For example, the artificial intelligence control system may develop the capability to decide what a particular input, such as a mouse or finger gesture, actually means in the game universe at a particular moment in time while treating that same input differently under a different context within the game environment or for a different user. In the flight simulation embodiment, the artificial intelligence powered game engine may interpret a finger input in an upper right-hand side of the display as meaning that the user wishes the plane to fly in that general direction. However, if the player is currently chasing another aircraft or entering into a combat area, the same finger input may be interpreted by the artificial intelligence powered game engine as an indication that the user wants to engage a particular aircraft. Further, if the player is engaged in a combat situation such as a dog fight, the finger input may be interpreted by the artificial intelligence powered game engine as an indication that the user wishes to fire their aircraft's guns or missiles in that direction.

The artificial intelligence powered game engine may then convert this inference into a set of instructions (106) and execute those instructions (108) within the game environment. The results of the executed instruction may then be reflected in the player's action within the game (110).

The artificial intelligence powered game engine may also be configured to command NPCs to respond to the received user inputs. For example, if the artificial intelligence powered game engine interprets that the user is engaging with or firing at a NPC controlled aircraft, then the artificial intelligence powered game engine may command the NPC to take evasive action or counter attack. Similarly, in a multi-player game environment, the artificial intelligence powered game engine may interpret one user's input and communicate the inferred in-game response to other players that are on the user's team.

To make this possible, the artificial intelligence powered game engine must be trained to understand the capabilities of a given object. For example, in a flight game played on a mobile phone or tablet, a first NPC, such as a virtual pilot that is capable and competent in flying the aircraft must be created. This requires the artificial intelligence powered game engine to go through multiple phases of training as detailed below. Once a virtual pilot that is capable of flying the aircraft has been trained, an additional layer of artificial intelligence analyzes an input from the player/pilot and tries to understand, or predict, what the player (user) intended by a fairly small and relatively ill-defined gesture on the screen of the mobile phone or tablet. Again, the artificial intelligence powered game engine goes through multiple phases of training to determine appropriate and contextually correct predictions of the player's intent.

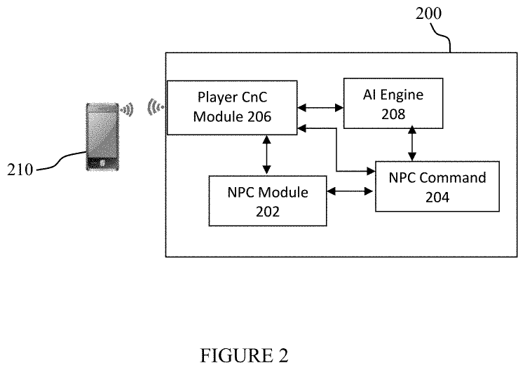

In one embodiment, three levels of artificial intelligence training work together to allow the artificial intelligence powered game engine to accurately determine both user intent and NPC behaviors within the game environment. Referring now to FIG. 2, the system 200 may comprise a NPC module 202, a NPC command module 204, and a player command and control (CnC) module 206 that receives inputs from a user device 210. The system 200 may reside, or otherwise be installed, on the user device 210 or it may reside on a cloud-based application server.

The NPC module 202 is responsible for learning how to control objects in game. The NPC module 202 may comprise any suitable information or data for controlling NPCs such as data for controlling physical motion, animation and logic. The NPC module 202 may also comprise constraints on NPCs that limit NPC ability or behavior. The MPC module 202 may also comprise a plurality of individual NPCs that operate within the game environment wherein the NPC module 202 is configured to constrain and control the operation and movement of each individual NPC within the game environment.

For example, the first challenge is for the artificial intelligence powered game engine 208 to understand what “success” looks like for any given operation. The goal may be as simple as get from “point A to point B” or as sophisticated as “complete the level in under 20 minutes” but the objectives need to reflect the types of controls and feedback that is available at any stage of development. In a first training regimen, the artificial intelligence powered game engine 208 may be tasked with an objective such as navigate from point A to point B. Initially, the artificial intelligence powered game engine 208 may learn the shortest path between points A and B. If, however, the learned path involves walking through a lake, then the artificial intelligence powered game engine 208 may be instructed to add a limitation that walking through a lake is a “negative” behavior and the training is run again. Additional iterations may be run until the artificial intelligence powered game engine 208 learns to reduce or avoid negative behaviors and select positive behaviors. After a sufficient number of iterations, the artificial intelligence powered game engine 208 may learn that there are several options for meeting the objective and each option may be saved and/or ranked for later use or recall.

This is, of course, an oversimplified example, but positive and negative values can be assigned to various attributes during or prior to the beginning of training. For example, in the case of a NPC that involves a person within the game, a skeleton may be created that by definition has certain limitations on how the body may move in space so that bending beyond the normal inflections for the skeleton are indicated as negative values, but staying within the “normal” parameters of skeletal movement are positive values. The artificial intelligence powered game engine 208 may then use these parameters to learn how to make the NPC walk, run, crawl, hide, or any other suitable movement.

The NPC module 202 may also comprise information used by the artificial intelligence powered game engine 208 to limit capabilities of the NPCs. For example, NPCs may have limitations as to physical strength, speed, or accuracy. This limitation may vary according to any desired criteria. In one embodiment, NPCs may be allowed to become more powerful at higher levels but not so much so that they cannot be defeated by the player. In this way, the artificial intelligence powered game engine 208 may learn at a similar rate as the player resulting in a varying difficulty level. In contrast, prior art NPCs may simply be programmed to appear at specific levels of a game such that more powerful NPCs do not appear as often when the player is at a low level but may appear more often as the player advances through the game.

In another embodiment, in a game where a player flies a dragon, the artificial intelligence powered game engine 208 may first have to teach the dragon to fly. For example, after a dragon recently has learned how to fly 15 meters/second the artificial intelligence powered game engine 208 may spend more time exploring how to accelerate from this speed to another speed but not waste time learning what to do at 0 meters/second.

Once the NPC module 202 is capable of manipulating the objects in space, the NPC command module 204 must be trained to create what can be thought of as strategic or tactical sets of instructions for each individual NPC to follow. More specifically, the NPC module 202 deals with more simple functions or actions like moving a character's legs to walk or lifting the character's arm(s) to fire a weapon. Conversely, the NPC command module 204 training regimen involves numerous execution cycles of fundamental game events at first. As these fundamentals are learned, the training of the NPC command module 204 gradually builds towards having a NPC perform specific tactical objectives. As tactical objectives are learned, the training may evolve to include the incorporation of advanced moves or maneuvers into the NPCs actions to provide a more visually appealing or dramatic scenario. Training may also include comparing or ranking various moves, maneuvers, tactics, or the like against each other to form a set or ranking of actions or suggestions that may be preferable over other actions or suggestions for a given condition. For example, a barrel roll in an aircraft may rank high for an evasive maneuver or for a stunt, but it may rank lower as a chasing tactic or an attack. Upon completion of the training the NPC can play an entire game session independently. In short, the NPC module 202 relies on the NPC command module 204 to select where to go and what to shoot at.

The NPC command module 204 may also be configured to integrate actions of actual players into the training of NPCs. This may help the game itself evolve as players improve and take actions that were not part of the initial training criteria or may have ranked lower or higher during training but perform differently in actual in-game conditions.

The final layer of training is the player CnC module 206 which receives discrete user inputs and examines the various capabilities that have been developed by the NPC command module 204 to infer an appropriate in-game response based on the discrete user inputs received by the player. The player CnC module 206 may be influenced by the NPC command module 204 and the NPC module 202 with respect to suggestions for actions that are available to the player in a given context or in-game situation based on the training of NPCs.

The inputs received by the player CnC module 206 may vary according to the computing platform or device being used by the player. In one embodiment, the player CnC module 206 may simply receive touch commands from the player. The artificial intelligence powered game engine 208 may then respond to these minimal platform specific discrete user inputs and infer optimal in-game action.

The player CnC module 206 may also be configured to account for varying ability of individual players in view of other metrics. For example, if the difficulty is too great, player retention may be impacted due to frustration of not being able to get beyond a certain level or task. Similarly, player retention may be impacted if the game is perceived by the player as too easy or simple. Therefore, the player CnC module 206 may be adapted to not only assess the quality of individual players but also assess the complexity of various tasks and the suitability of individual players for specific tasks.

Training of the player CnC module 206 may also include other factors aimed at maintaining or improving player retention. For example, the artificial intelligence powered game engine 208 may be provided with metrics relating to actions taken by players in response to certain in-game activities and associate higher rated actions as a positive behavior and low rated actions as a negative behavior. For example, if the game allows players to view a “replay” of some in-game action such as the destruction of a main target, the player CnC module 206 may record the number of occurrences a given replay achieves across all players. If a certain replay is viewed more often than others or receives higher ratings, then that replay may be given a higher score for use by the artificial intelligence powered game engine 208 during subsequent training.

Additional factors that may be included in the training metrics may also include feedback external to the game environment. This feedback may relate to any desired criteria such as player engagement or elements that affect monetization of the game. Player reactions to specific events or action within the game may also be used as training metrics. These criteria may be used as inputs to the training of both the player CnC module 206 and the NPC command module 204.

The player CnC module 206 may also be trained to adjust a viewpoint during gameplay to increase a player's enjoyment of the game. For example, a majority of a given game may be viewed from the player's perspective. This perspective may be altered at certain points during gameplay to provide a viewpoint from another angle or perspective. As one example, if a player chooses to attack an enemy and fires a missile, the viewpoint on the screen of the user device may change to show the enemy's viewpoint as the attack occurs. Alternatively, the viewpoint on the screen of the user device may change to a third person viewpoint such that the entirety of the attack may be viewed.

Ratings of any given action may be non-static in that each rating may be adjusted in real-time or on a predetermined interval to take into account any changing views or attitudes of the players. This may allow for an action that received an early number of high ratings to lose some status over time if it becomes less popular among players.

In operation, the player CnC module 206 receives inputs from the player/user during gameplay. Player inputs may comprise any suitable type of input and may be an active form of input or a passive input. In one embodiment, player inputs may comprise active gestures, motions, touch commands, voice commands, or other like actions taken on the user device 210 intended to express an intent during gameplay. For example, one form of an active input may comprise the player touching an upper right-hand side of the display during a flight simulation game to indicate that the user wishes the plane to fly in that general direction. In the same flight simulation, a swiping gesture may indicate that the player wishes to move the field of view in the direction of the gesture while not altering the general direction of flight or travel. Similarly, the player may tilt or rotate the computing device as a form of input or use voice commands.

In an alternative embodiment, user inputs may be passive and instead generated according to a set of contextual rules or parameters. For example, in an application used to control or hail an autonomously driven vehicle, the player CnC module 206 may recognize as an input the user stepping towards a curb along a roadside at 6:30 am as an indication that the user wishes to be taken to a local coffee shop. Another passive movement such as the user walking through a wirelessly fenced region may be an indication that the user wishes to pay for any items that they may collected while inside of a store.

The artificial intelligence powered game engine 208 uses these inputs to advance gameplay by inferring an in-game response based on the received input or by initiating an appropriate real-world response according to the received input. This may result in a given input resulting in a different in-game response depending on changing in-game conditions.

Returning to the flight simulation embodiment, in one context or situation within the game environment the artificial intelligence powered game engine 208 may interpret a finger input as meaning that the player wishes the plane to fly in that general direction. In another context or situation within the game environment the same finger input may be interpreted by the artificial intelligence powered game engine 208 as an indication that the user wants to engage a particular aircraft, fire their aircraft's guns or missiles in that direction, join a squadron of aircraft, disengage from a dogfight, or any other suitable response based on how the player CnC module 206 has been trained or based on the actual desired intent of a given user in prior similar game situations.

The artificial intelligence powered game engine 208 provides the player with the ability to perform any task, skill, or action during gameplay with only minimal input. This may allow players to enjoy a game without having to master skills or use additional input devices to play the game.

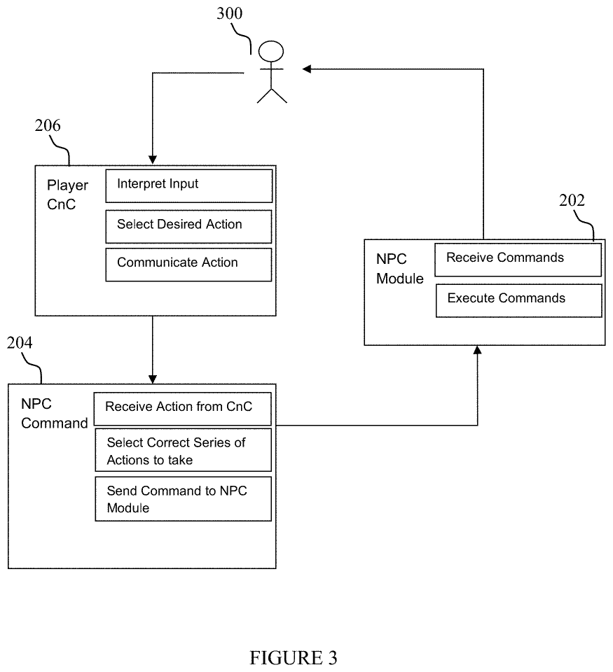

For example, and referring now to FIG. 3, in a game the player may provide an input intended to have their character 300 within the game perform an action. That input is communicated to the player CnC module 206 and the artificial intelligence powered game engine 208 may infer the player's intent. That intent is then communicated to the NPC command module 204 where the intent is converted into a set of actions such as a series of moves, an attack sequence, or other like action within the game environment which are communicated to the NPC module 202. The NPC module 202 may then signal to a regular game engine used to operate the game during gameplay to have the player's character 300 perform the intended actions.

The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing specification, the technology has been described with reference to specific exemplary embodiments. Various modifications and changes may be made, however, without departing from the scope of the present technology as set forth in the claims. The specification and figures are illustrative, rather than restrictive, and modifications are intended to be included within the scope of the present technology. Accordingly, the scope of the technology should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims. As used herein, the terms “comprise,” “comprises,” “comprising,” “having,” “including,” “includes,” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A system for providing an artificial intelligence (AI) powered response to user inputs in an environment, comprising:
a non-player character (NPC) module storing a plurality of non-player characters (NPCs) found within the environment;
a NPC command module linked to the NPC module and configured to provide commands to individual NPCs to affect behaviors and actions of the NPCs within the environment;
a player command and control (CnC) module configured to:
offer CnC suggestions to an individual player; and
receive discrete user inputs; and
an AI powered engine configured to:
train each NPC to perform a set of actions within the environment according to a set of functional boundary conditions;
train the NPC module to command the plurality of NPCs;
train the player CnC module to learn a plurality of CnC suggestions according to individual player actions; and
infer an in-environment response based on the discrete user inputs received by the player CnC module according to the learned plurality of CnC suggestions.

2. A system for providing an AI powered response to user inputs in an environment according to claim 1, further comprising a user interface displayed to the user and configured to:
display in-environment action to the player;
capture the discrete user inputs; and
communicate the captured discrete user inputs to the player CnC module.

3. A system for providing an AI powered response to user inputs in an environment according to claim 2, wherein the AI powered engine is further configured to:
infer a first in-environment response for a first discrete user input according to a first contextual situation within the environment; and
infer a second in-environment response for the first discrete user input according to a second contextual situation of the environment.

4. A system for providing an AI powered response to user inputs in an environment according to claim 1, wherein the AI powered engine is further configured to infer the in-environment response according to a contextual situation of the environment.

5. A system for providing an AI powered response to user inputs in an environment according to claim 1, wherein training each NPC comprises:
performing a first series of iterations where a first NPC is taught to perform a first set of actions;
determining a measure of success for each iteration in the first series of iterations;
ranking the measure of success for each iteration in the first series of iterations against previous iterations with the AI powered engine to achieve higher level results;
performing a second series of iterations where the first NPC is taught to perform a second set of actions that are conditioned on the first set of actions;
determining a measure of success for each iteration in the second series of iterations; and
ranking the measure of success for each iteration in the second series of iterations against previous iterations with the AI powered engine to achieve higher level results.

6. A system for providing an AI powered response to user inputs in an environment according to claim 5, wherein the first and second series of iterations are constrained by a set of negative and positive values assigned to various NPC attributes.

7. A system for providing an AI powered response to user inputs in an environment according to claim 5, wherein training the NPC command module comprises:
performing a first series of events according to the first and second set of actions; and
performing a first series of objectives that are conditioned on the first series of events.

8. A system for providing an AI powered response to user inputs in an environment according to claim 7, wherein the AI powered engine is further configured to include received discrete user inputs into the first series of events and the first series of objectives.

9. A system for providing an AI powered response to user inputs in an environment according to claim 7, wherein training the NPC command module further comprises incorporating training metrics that include feedback external to the environment.

10. A system for providing an AI powered response to user inputs in an environment according to claim 1, wherein training the player CnC module comprises:
receiving a first discrete user input;
comparing a current in-environment situation to known similar in-environment situations trained into the NPC command module;
determining a set of available behaviors and actions relating to the current in-environment situation;
comparing the set of available behaviors and actions to known inputs for causing each behavior and action from the set of behaviors and actions; and
selecting a desired in-environment response according to the known inputs for causing each behavior and action that best relates to the received user input.

11. A system for providing an AI powered response to user inputs in an environment according to claim 10, wherein the AI powered engine is further configured to incorporate player feedback of the selected in-environment response into the known inputs.

12. A system for providing an AI powered response to user inputs in an environment according to claim 10, wherein training the player CnC module further comprises incorporating alternate viewpoints into the environment following the inference of the in-environment response.

13. A system for providing an AI powered response to user inputs in an environment according to claim 10, wherein training the player CnC module further comprises incorporating training metrics that include feedback external to the environment.

14. A method for providing an artificial intelligence (AI) powered response to user inputs in an environment, comprising:
storing a plurality of non-player characters (NPCs) found within the environment in a non-player character (NPC) module;
providing commands to individual NPCs to affect behaviors and actions of the NPCs within the environment with a NPC command module linked to the NPC module;
offering command and control (CnC) suggestions to an individual player with a player CnC module;
receiving discrete user inputs with the player CnC module;
training each NPC within the environment to perform a set of actions within the environment according to a set of functional boundary conditions with an AI powered engine;
training the NPC module with the AI powered engine to command the plurality of NPCs;
training the player CnC module with the AI powered engine to learn a plurality of CnC suggestions according to individual player actions; and
inferring an in-environment response with the AI powered engine based on the discrete user inputs received by the player CnC module according to the learned plurality of CnC suggestions.

15. A method for providing an AI powered response to user inputs in an environment according to claim 14, further comprising a user interface displayed to the user and configured to:
display in-environment action to the player;
capture the discrete user inputs; and
communicate the captured discrete user inputs to the player CnC module.

16. A method for providing an AI powered response to user inputs in an environment according to claim 15, wherein the AI powered engine is further configured to:
infer a first in-environment response for a first discrete user input according to a first contextual situation of the environment; and
infer a second in-environment response for the first discrete user input according to a second contextual situation of the environment.

17. A method for providing an AI powered response to user inputs in an environment according to claim 14, wherein the AI powered engine is further configured to infer the in-environment response according to a contextual situation of the environment.

18. A method for providing an AI powered response to user inputs in an environment according to claim 14, wherein training each NPC comprises:
performing a first series of iterations where a first NPC is taught to perform a first set of actions;
determining a measure of success for each iteration in the first series of iterations;
ranking the measure of success for each iteration in the first series of iterations against previous iterations with the AI powered engine to achieve higher level results;
performing a second series of iterations where the first NPC is taught to perform a second set of actions that are conditioned on the first set of actions;
determining a measure of success for each iteration in the second series of iterations; and
ranking the measure of success for each iteration in the second series of iterations against previous iterations with the AI powered engine to achieve higher level results.

19. A method for providing an AI powered response to user inputs in an environment according to claim 18, wherein the first and second series of iterations are constrained by a set of negative and positive values assigned to various NPC attributes.

20. A method for providing an AI powered response to user inputs in an environment according to claim 18, wherein training the NPC command module comprises:
performing a first series of events according to the first and second set of actions; and
performing a first series of objectives that are conditioned on the first series of events.

21. A method for providing an AI powered response to user inputs in an environment according to claim 20, wherein the AI powered engine is further configured to include received discrete user inputs into the first series of events and the first series of objectives.

22. A method for providing an AI powered response to user inputs in an environment according to claim 20, wherein training the NPC command module further comprises incorporating training metrics that include feedback external to the environment.

23. A method for providing an AI powered response to user inputs in an environment according to claim 14, wherein training the player CnC module comprises:
receiving a first discrete user input;
comparing a current in-environment situation to known similar in-environment situations trained into the NPC command module;
determining a set of available behaviors and actions relating to the current in-environment situation;
comparing the set of available behaviors and actions to known inputs for causing each behavior and action from the set of behaviors and actions; and
selecting a desired in-environment response according to the known inputs for causing each behavior and action that best relates to the received user input.

24. A method for providing an AI powered response to user inputs in an environment according to claim 23, wherein the AI powered engine is further configured to incorporate player feedback of the selected in-environment response into the known inputs.

25. A method for providing an AI powered response to user inputs in an environment according to claim 23, wherein training the player CnC module further comprises incorporating alternate viewpoints into the environment following the inference of the in-environment response.

26. A method for providing an AI powered response to user inputs in an environment according to claim 23, wherein training the player CnC module further comprises incorporating training metrics that include feedback external to the environment.
